(19) United States
(12) Patent Application Publication
(10) Pub. No.: US 2025/0309933 A1
(43) Pub. Date: Oct. 2, 2025

(54) RADIO-FREQUENCY FRONT-END CIRCUIT WITH ADJUSTABLE OPERATION MODES

(71) Applicant: Apple Inc., Cupertino, CA (US)

(72) Inventors: Hossein NAJAFIAGHDAM, New York, NY (US); Mahdi KHOSHGARD, Los Gatos, CA (US); Mansour KERAMAT, Los Gatos, CA (US); Mengyang YUAN, Sunnyvale, CA (US); Sebastian REINHOLD, Muenchen (DE)

(21) Appl. No.: 18/618,430

(22) Filed: Mar. 27, 2024

(51) Int. Cl. H04B 1/16

(52) U.S. Cl. CPC H04B 1/16

(57) ABSTRACT

A front-end circuit for a radio-frequency receiver circuit in a computer system is disclosed. The front-end circuit may include an analog-to-digital converter circuit that samples a received input signal to generate a stream of samples. The front-end circuit may also include a filter circuit that digitally filters the stream of samples to generate output data. A control circuit included in the front-end circuit may analyze the stream of samples to detect the presence of a blocker of the input signal and adjust the resolution of the analog-to-digital converter circuit and the filter circuit based on whether or not the input signal is blocked.

### FIELD

The described embodiments relate generally to integrated circuits and, more particularly, to techniques for adjusting operation modes of a radio-frequency front-end circuit.

### BACKGROUND

Radio-frequency receiver circuits are used in a variety of applications. Devices such as television receivers, cordless telephones, cellular telephones, and the like, can employ radio-frequency circuits to receive radio-frequency signals and convert them to lower-frequency or digital information that can be used by the devices. Such radio-frequency signals may be transmitted through the atmosphere, free space, optical or coaxial cables, or any other suitable medium.

Many mobile computing devices, e.g., tablets, smartphones, and the like, can employ radio-frequency receiver circuits to receive data from a wireless computer network. Some mobile computing devices such as smartphones, can receive signals from a global positioning system (“GPS”) or from a global navigation satellite system (“GNSS”). Such signals can be used to determine a location of a mobile computing device.

### BRIEF DESCRIPTION OF THE DRAWINGS

FIG. 1 is a block diagram depicting an embodiment of a front-end circuit of a radio-frequency receiver circuit.

FIG. 2 is a block diagram depicting an embodiment of an analog-to-digital converter circuit.

FIG. 3 is a block diagram depicting an embodiment of a successive-approximation register circuit.

FIG. 4A is a block diagram depicting an embodiment of a half-band filter circuit.

FIG. 4B is a block diagram of an embodiment of a glitch-free switch circuit for use in a filter circuit.

FIG. 5A is a block diagram depicting an embodiment of a resolution change in a filter circuit.

FIG. 5B is a block diagram depicting another embodiment of a resolution change in a filter circuit.

FIG. 6 is a block diagram depicting an embodiment of a radio-frequency receiver subsystem.

FIG. 7 is a flow diagram of an embodiment of a method for operating a front-end circuit for a radio-frequency circuit.

FIG. 8 is a flow diagram of an embodiment of a method for analyzing samples of an input signal.

FIG. 9 is a block diagram of an embodiment of a device that includes a radio-frequency receiver subsystem.

FIG. 10 is a block diagram of various embodiments of computer systems that may include power management circuits.

FIG. 11 illustrates an example of a non-transitory computer-readable storage medium that stores circuit design information.

### DETAILED DESCRIPTION

Computer systems may include radio-frequency receiver circuits configured to receive and process radio-frequency signals. For example, a computer system may include a radio-frequency receiver circuit configured to receive a radio-frequency signal from a wireless computer network, e.g., WiFi.

Some computer systems may include radio-frequency receiver circuits configured to receive GPS or GNSS signals, and use such signals to determine their location. The determined location can, in some cases, be used as part of a navigation system that can provide a user with directions to reach a particular destination.

In some computer systems, a radio-frequency signal is converted by a front-end circuit to a stream of samples. The stream of samples can be digitally filtered to create output data that can be further processed to extract encoded information, e.g., location information from the output data. Each sample can include multiple bits whose aggregate value corresponds to a magnitude of the radio-frequency signal at a particular point in time. In various front-end circuits, the number of bits included in a given sample is determined by an analog-to-digital converter circuit that samples the radio-frequency signal.

In some situations, a radio-frequency signal may be corrupted by a signal blocker. As used and described herein, a signal blocker (or simply “blocker”) refers to any circuit generating a signal that occupies a same, close, or neighboring channel as a particular radio-frequency channel that results in corruption of the particular radio-frequency signal. For example, a blocker for a GNSS signal may include circuits generating WiFi signals, or cellular long-term evolution (LTE) HD2 routers, and the like. When a radio-frequency signal is blocked, it becomes more difficult to detect the radio-frequency signal.

In many computer systems, to account for blockers, the resolution of front-end analog-to-digital converter circuits and filter circuits has to be increased to ensure proper detection of a radio-frequency signal. In general, the respective power consumed by the analog-to-digital converter circuits and filter circuits is proportional the respective number of bits associated with the analog-to-digital converter circuits and filter circuits. Since blockers are not always present, there is a portion of time during which the respective power consumptions of the analog-to-digital converter circuits and filter circuits are greater than are needed. Such additional power consumption places additional demands on thermal management systems and, in the case of mobile devices, can reduce battery life.

The embodiments illustrated in the drawings and described below provide techniques for detecting the presence of a signal blocker and adjusting respective resolutions of an analog-to-digital converter circuit and a filter circuit based on whether a signal blocker is present. By adjusting the respective resolutions of the analog-to-digital converter circuit and the filter circuit, the power consumption of a front-end circuit can be reduced during periods where the input signal is not blocked.

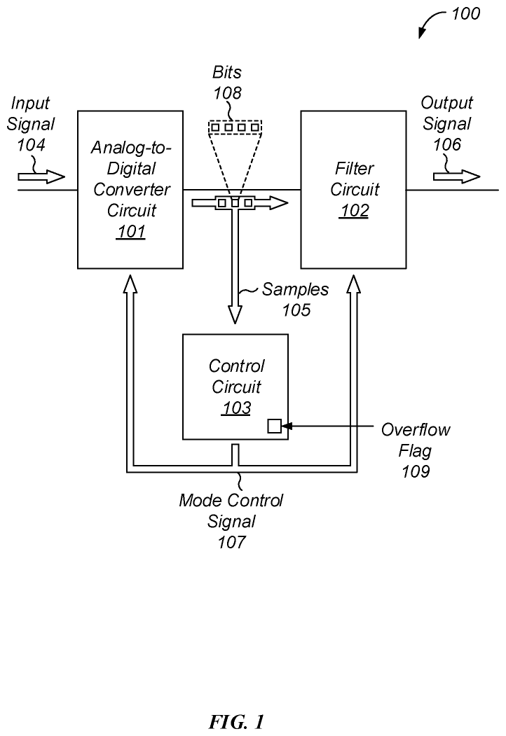

A block diagram of a front-end circuit of a radio-frequency receiver circuit is depicted in FIG. 1. As illustrated, front-end circuit 100 includes analog-to-digital converter circuit 101, filter circuit 102, and control circuit 103.

Analog-to-digital converter circuit 101 is configured to receive input signal 104 and sample input signal 104 to generate samples 105. In various embodiments, a given one of samples 105 includes bits 108. Although input signal 104 is depicted as a single signal, in various embodiments, input signal 104 may be differentially encoded and may be received via multiple wires or conductive traces. In some embodiments, input signal 104 may correspond to a GNSS signal.

A number of bits 108 is based on a resolution of analog-to-digital converter circuit 101. In various embodiments, analog-to-digital converter circuit 108 may be implemented using a flash analog-to-digital converter circuit, a successive-approximation register (SAR) analog-to-digital converter circuit that employs one or more capacitive digital-to-analog converter circuits, or any other suitable analog-to-digital converter circuit topology.

Filter circuit 102 is configured to filter samples 105 to generate output signal 106. In various embodiments, filter circuit 102 may be implemented as a half-band filter. As used herein, a half-band filter is a low-pass filter that is configured to reduce a maximum bandwidth of data samples by a factor of 2. In various embodiments, a resolution of filter circuit 102 is the same as the resolution of analog-to-digital converter circuit 101. It is noted that, in some embodiments, filter circuit 102 may include fractional bits in addition to bits used by analog-to-digital converter circuit 108.

Control circuit 103 is configured to perform an analysis of samples 105. In various embodiments, control circuit 103 is further configured to change, based on a result of the analysis, a resolution of analog-to-digital converter circuit 101. Control circuit 103 is additionally configured to change, based on the result of the analysis, a resolution of filter circuit 102. In various embodiments, changing the resolution of analog-to-digital converter circuit 101 and filter circuit 102 including ignoring or “muting” portions of data words being processed. For example, control circuit 103 may change the resolution of analog-to-digital converter circuit 101 and filter circuit 102 from 10-bits to 6-bits or vice versa. In some cases, one or more most-significant-bits may be muted while, in other cases, one or more least-significant-bits can be muted. It is noted that the use of 10-bits and 6-bits for the different resolutions is merely an example. In other embodiments, any suitable number of bits may be used for each resolution, provided that a number of bits employed in low-resolution mode is less than a number of bits employed in high-resolution mode.

By switching the resolution of analog-to-digital converter circuit 101 and filter circuit 102, the power consumption of front-end circuit 100 can be adjusted to allow for the presence of blockers corrupting the input signal. When a blocker is detected, control circuit 103 can increase the resolution of analog-to-digital converter circuit 101 and filter circuit 102 to compensate for the signal corruption at the expense of operating in a high-power mode. When the blocker is no longer present and the input signal is no longer being corrupted, control circuit 103 can reduce the resolution of analog-to-digital converter circuit 101 and filter circuit 102 to save power by operating in a low-power mode.

To change the resolution of analog-to-digital converter circuit 101, control circuit 103 is further configured to increase the resolution of analog-to-digital converter circuit 101 in response to a determination that the number of clipped samples exceeds a first threshold value. In other embodiments, control circuit 103 is further configured to decrease the resolution of analog-to-digital converter circuit 101 in response to a determination that the number of clipped samples is less than a second threshold value. In some embodiments, the second threshold value is the same as the first threshold value.

In a similar fashion, to change the resolution of filter circuit 102, control circuit 103 is further configured to increase the resolution of filter circuit 102 in response to a determination that the number of clipped samples exceeds a first threshold value. In other embodiments, control circuit 103 is further configured to decrease the resolution of filter circuit 102 in response to a determination that the number of clipped samples is less than a second threshold value. In various embodiments, the resolution of filter circuit 102 may be the same as the resolution of analog-to-digital converter circuit 101.

As described below, to perform the analysis of samples 105, control circuit 103 is configured to determine a number of clipped samples included in samples 105 over a particular period of time, and perform a comparison of the number of clipped samples to at least one threshold value. As used herein, a clipped sample refers to a sample whose bit values are a maximum or minimum value in low-resolution mode. Overflow flag 109 is activated in response to a determination that a particular one of samples 105 is greater than an upper threshold or less than a lower threshold. It is noted that the particular period of time may, in some embodiments, be implemented as a moving window whose width can be adjusted based on a type of blocker that is trying to be detected.

In some embodiments, control circuit 103 may be configured to predict a value of a next overflow flag using a history of previous overflow flag values. Control circuit 103 may, in some cases, use predicted overflow flag values to detect corruption in input signal 104 caused by a blocker and activate mode control signal 107 in response to such a detection. In some embodiments, control circuit 103 may be additionally configured to perform a smoothing filter operation on the predicted overflow flag values prior to performing the threshold comparisons.

Control circuit 103 may be implemented using any suitable microcontroller, processor circuit or the like. In some embodiments, control circuit 103 may include one or more register files, static random-access memory (SRAM) circuits, as well as any suitable combination of combinatorial and sequential logic circuits.

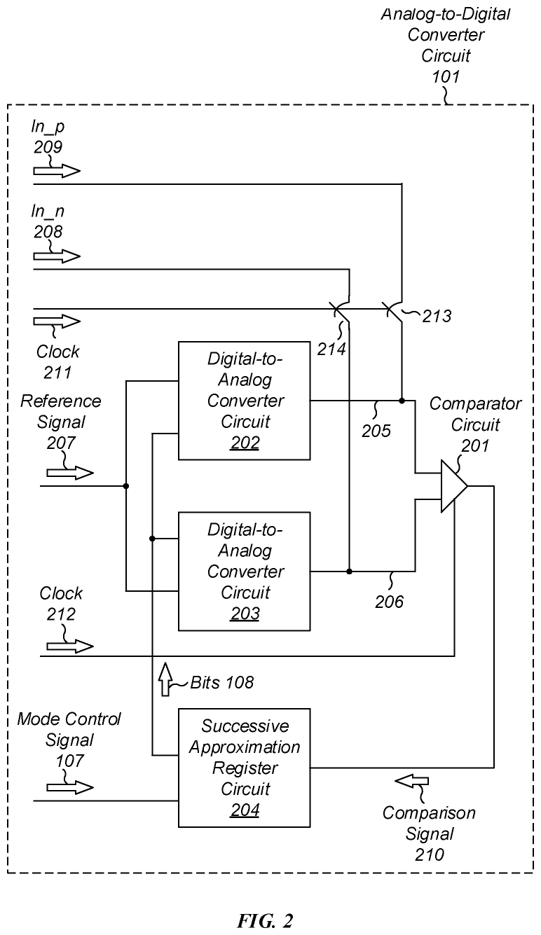

Turning to FIG. 2, a block diagram of an embodiment of an analog-to-digital converter circuit is depicted. As illustrated, analog-to-digital converter circuit 101 includes comparator circuit 201, digital-to-analog converter circuits 202 and 203, successive approximation register circuit 204, and switches 213 and 214.

Analog-to-digital converter circuit 101 can be configured to operate in two phases based on a value of clocks 211 and 212. During a sample phase, clock 211 is activated which closes switches 213 and 214, coupling in_p 209 and in_n 208 to nodes 205 and 206, respectively. In various embodiments, in_n 208 and in_p 209 correspond to a differentially encoded input signal 104.

While in_n 208 is coupled to node 206, capacitors included in digital-to-analog converter circuit 203 are coupled between node 206 and reference signal 207, charging the capacitors to a voltage difference between reference signal 207 and in_n 208. In a similar fashion, when in_p 209 is coupled to node 205, capacitors included in digital-to-analog converter circuit 202 are coupled between node 205 and reference signal 207, charging the capacitors to a voltage difference between reference signal 207 and in_p 209.

In various embodiments, digital-to-analog converter circuits 202 and 203 include an array of capacitors with binary weighted values. The number of capacitors used can correspond to the maximum resolution of front-end circuit 100. For example, in some cases, the maximum resolution of front-end circuit 100 is 10-bits. Accordingly, digital-to-analog converter circuits 202 and 203 each include 9 capacitors, which may be controlled by bits <9:1> of bits 108. It is noted that, in other embodiments, different circuit topologies, which may include different numbers of capacitors, may be employed.

During a conversion phase, clock 211 is deactivated, opening switches 213 and 214, thereby decoupling in_n 208 from node 206, and decoupling in_p 209 from node 205. Additionally, comparator circuit 201 is activated by an activation of clock 212. Comparator circuit 201 is configured to generate comparison signal 210 based upon a comparison of the respective voltage levels of nodes 205 and 206.

Successive-approximation register circuit 204 is configured to generate bits 108 using comparison signal 210. In various embodiments, digital-to-analog converter circuits 202 and 203 are configured to adjust which of their respective capacitors are coupled to nodes 205 and 206 based on bits 108. By adjusting which capacitors are coupled to nodes 205 and 206, digital-to-analog converter circuits 202 and 203 change the voltage levels on nodes 205 and 206 which, in turn, can change the value of comparison signals 210. The process of successive-approximation register circuit 204 adjusting the value of bits 108 continues until the voltage levels of nodes 205 and 206 reach a common mode voltage. At that point, the values of bits 108 are saved as one of samples 105 and sent to filter circuit 102.

Successive-approximation register circuit 204 is further configured to mute one or more of bits 108 based on mode control signal 107. As described below, successive-approximation register circuit 204 may mute one or more of the most-significant bits of bits 108. Alternatively, successive-approximation register circuit 204 may mute one or more of the least-significant-bits of bits 108. By muting at least some of bits 108, successive-approximation register circuit 204 can reduce the power consumption due to switching in digital-to-analog converter circuits 202 and 203. It is noted that although mode control signal 107 is depicted as a single signal, in other embodiments, mode control signal 107 may include multiple signals for controlling the operation of successive-approximation register circuit 204.

In various embodiments, switches 213 and 214 may be implemented using complementary metal-oxide semiconductor (CMOS) pass gates that include at least one n-channel metal-oxide semiconductor field-effect transistor (MOSFET) and at least one p-channel MOSFET. In other embodiments, any suitable combination of MOSFETs or other switching circuit elements may be employed.

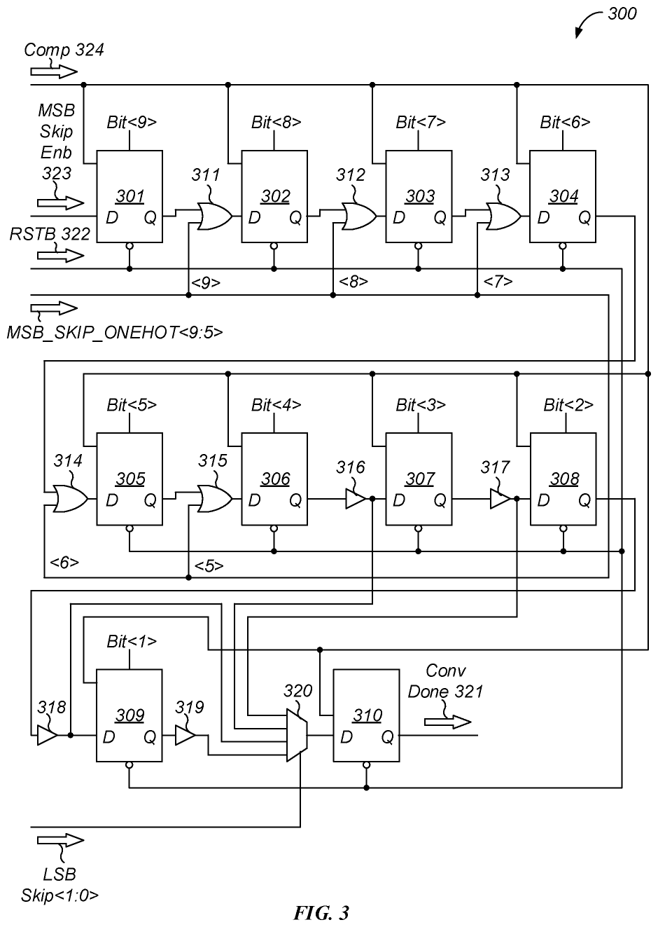

Turning to FIG. 3, a block diagram of a successive-approximation register circuit is depicted. As illustrated, successive-approximation register circuit 300 includes flip-flop circuits 301-310, OR-gates 311-315, buffer circuits 316-319, and multiplex circuit 320. In various embodiments, successive-approximation register circuit 300 may correspond to successive-approximation register circuit 204 as depicted in FIG. 2.

OR-gates 311-315 and buffer circuits 316-319 are interspersed between flip-flop circuits 301-310, which are arranged in a daisy chain fashion. Individual ones of flip-flop circuits 301-310 are configured to generate corresponding ones of bits<9:1>. In some embodiments, flip-flop circuits 301-310 are also configured to reset in response to an activation of RSTB 322. It is noted that, in some embodiments, RSTB 322 is an active low signal. In various embodiments, bits<9:1> correspond to bits 108 as depicted in FIGS. 1 and 2.

In various embodiments, OR-gates 311-315 allow the conversion process to start at different points in the chain of flip-flop circuits 301-306. By activating different ones of MSB_skip_onchot<9:5> and with MSB skip enb 323, only 1 D-input of flip-flop circuits 301-306 is set to one at the beginning of a conversion cycle, allowing some of flip-flop circuits 301-306 to be skipped in order to change the resolution of successive-approximation register 300.

In various embodiments, a comparison signal (denoted as “comp 324”) may be coupled to the respective clock inputs of flip-flop circuits 301-306. It is noted that although comp 324 is depicted as a single wire, in some cases comp 324 may include two signals indicating the polarity comparator 201 detected. Based on comp 324, a given one of flip-flops circuits 301-306 will latch either a logical-0 or a logical-1, provided its corresponding D-input is at a logical-1 value. When the D-input value of one of flip-flop circuits 301-306 is a logical-0, that particular flip-flop circuit is disabled. In various embodiments, once flip-flop circuits 301-306 latch a value, flip-flop circuits 301-306 are configured to disable themselves and maintain their respective states until reset.

In additional to being able to skip ones of flip-flop circuits 301-310 associated with the most-significant-bits of bits<9:1>, successive-approximation register circuit 300 is also configured to allow least-significant-bits of bits<9:1> to be skipped as well. In various embodiments, skipping least-significant-bits instead of most-significant-bits can help preserve sign information of bits<9:1>. To skip least-significant-bits of bits<9:1>, different ones of LSB skip <1:0> can be activated, which controls multiplex circuit 320 to select outputs of different ones of flip-flop circuits 306-309. It is noted that when skipping least-significant-bits, conv done 321 will be activated 1 to 3 clock cycles sooner.

Flip-flop circuits 301-310 may, in various embodiments, be implemented as D-type flip-flop circuits, latches, or any other suitable sequential logic circuit. In some embodiments, OR-gates 311-315 may be implemented using NOR-gates and inverters, or any other suitable arrangement of logic gates configured to perform the logical-OR operation. In various embodiments, buffer circuits 316-319 may be implemented using multiple inverter circuits or any other suitable non-inverter amplifier circuit. Multiplex circuit 320 may, in some embodiments, be implemented using any suitable combination of combinatorial logic gates arranged to implement the multiplex function.

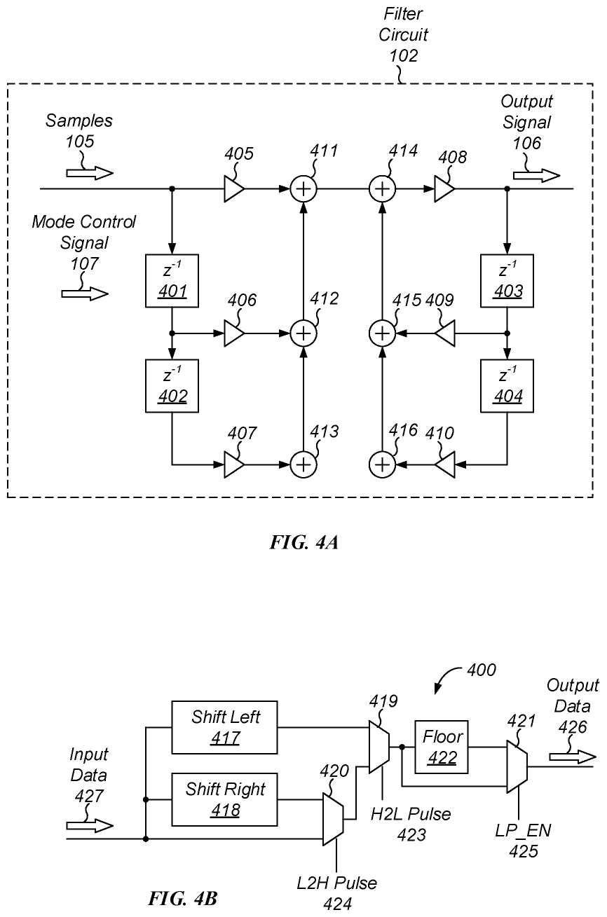

Turning to FIG. 4A, a block diagram of filter circuit 102 is depicted. In various embodiments, filter circuit 102 may be implemented as a half-band filter circuit that includes delay circuits 401-404 (denoted as “z⁻¹ 401-404”), gain circuits 405-410, and adder circuits 411-416. It is noted that while the embodiment depicted in FIG. 4A corresponds to a half-band filter, in other embodiments, other filter types are possible and contemplated. Although the connections between the components are depicted as single wires, in various embodiments, the connections between the components may include any suitable number of wires to support the highest resolution of which filter circuit 102 is capable. In various embodiments, portions of delay circuits z⁻¹ 401-404 corresponding to one or more least-significant-bits can be disabled, using mode control signal 107, when front-end circuit 100 is operating in low-power mode.

Each of delay circuits z⁻¹ 401-404 introduce one-cycle of delay between their respective inputs and outputs. In some embodiments, delay circuits z⁻¹ 401-404 may be implemented using two flip-flop circuits coupled in series, or any other suitable sequential logic circuit.

Gain circuits 405-410 are configured to provide generate respective output signals by applying corresponding gain factors to their respective input signals. In various embodiments, gain circuits 405-410 may be implemented using any suitable combination of logic gates.

Adder circuits 411-416 are configured to perform an addition operation on two operands to generate corresponding outputs. In various embodiments, adder circuits 411-416 may be implemented using multiple single-bit full-adder circuits, or any other suitable combinatorial logic circuits configured to generate a sum of two numbers. It is noted that adder circuits 411-416 can operate on a number of bits sufficient to support the full resolution of filter circuit 102. In some cases, at least some of the least-significant-bits of adder circuits 411-416 can be disabled, using mode control signal 107, when front-end circuit 100 is operating in low-power mode.

As described below, switching the resolution of filter circuit 102 can involve muting one or more least-significant-bits (LSBs) of the data being processed by filter circuit 102. In some cases, muting the LSBs of the data can include shifting the data in order to preserve sign information included in the most-significant-bit (MSB) of the data. As the shifting occurs, the outputs of delay circuits z⁻¹ 401-404 take a cycle longer to receive the shifted value. This delay can cause glitches at the inputs of delay circuits whose inputs include feedback from their outputs.

It is noted that the embodiment of filter circuit 102 depicted in FIG. 4A is merely an example. In other embodiments, different topologies of delay and gain circuits may be employed to implement the desired transfer function. In some cases, additional delay branches may be employed.

To remediate the glitches, a glitch-free switch circuit can be inserted before internal registers included in filter circuit 102. An embodiment of such a glitch-free switch circuit is depicted in FIG. 4B. As illustrated, glitch-free switch circuit 400 includes shift-left circuit 417, shift-right circuit 418, multiplex circuits 419-421, and floor circuit 422.

Shift-left circuit 417 is configured to generate a version of input data 427 that is shifted left by a particular number of bits that correspond to a number of bits that are muted when front-end circuit 100 is operating in low-power mode. In a similar fashion, shift-right circuit 418 is configured to generate a version of input data 427 that is shifted right by the particular number of bits.

Multiplex circuit 420 is configured, based on L2H pulse 424, to select between input data 427 and an output of shift-right circuit 418 to generate an output signal. In various embodiments, L2H pulse 424 is activated when front-end circuit 100 transitions from low-power mode to high-power mode. In a similar fashion, multiple circuit 419 is configured to select between the output of multiplex circuit 419 and the output of shift-left circuit 417 based on H2L pulse 423. In various embodiments, H2L pulse 423 is activated when front-end circuit 100 transitions from high-power mode to low-power mode.

Floor circuit 422 is configured to perform the mathematical floor function on the output of multiplex circuit 419. In various embodiments, the floor function generates a greatest whole number less than or equal to the input number. In various embodiments, floor circuit 422 may be implemented using any suitable combination of logic gates and/or MOSFETs.

Multiplex circuit 421 is configured to generate output data 426 by selecting the output of floor circuit 422 or the output of multiplex circuit 419 based on LP_EN 425. In various embodiments, LP_EN 425 is activated when front-end circuit 100 enters low-power mode. Output data 426 can, in various embodiments, be fed into the input of an internal register included in filter circuit 102.

In various embodiments, shift-left circuit 417 and shift-right circuit 418 may be implemented using a cascade of flip-flop circuits with the output of one flip-flop circuit connected to the input of a next flip-flop circuit. Multiplex circuits 419-421 may, in various embodiments, be implemented using any suitable combination of logic gates and/or MOSFETs configured to implement the multiplex function.

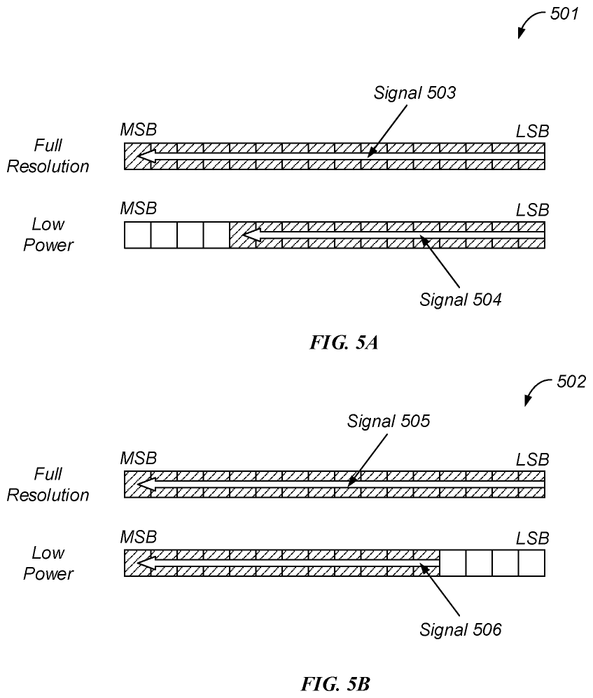

Turning to FIG. 5A, a block diagram depicting an embodiment of a resolution change in a filter circuit, e.g., filter circuit 102 as depicted in FIG. 1, is illustrated. Graph 501 shows the number of bits stored in an internal register or adder circuit of a front-end circuit during a full-resolution mode and a low-power mode. In various embodiments, the bits stored in the internal register or adder circuit may be stored in a 2′s-complement format. As described above, full-resolution mode may be employed when a blocker is corrupting input signal 104, and low-power mode may be employed when no blockers are present.

During full-resolution mode, all of the available bits are used to encode a value indicative of signal 503. When a blocker is no longer corrupting input signal 104, only a portion of the available bits are used to encode a value indicative of signal 504. As illustrated, the four most-significant-bits (MSBs) are not used to encode the value indicative of signal 504. Although four MSBs are depicted as being muted in low-power mode, in other embodiments, any suitable number of MSBs can be muted in low-power mode.

As described above, the MSBs can be muted in response to the detection of a signal block. In other embodiments, other changes in an input signal may be detected. In such cases, rather than muting MSBs, however, the least-significant-bits (LSBs) can be muted in response to the detected change in the input signal. Turning to FIG. 5B, a block diagram depicting another embodiment of a resolution change in a filter circuit, e.g., filter circuit 102 as depicted in FIG. 1, is illustrated. Graph 502 show the number of bits stored in an internal register or adder circuit in a front-end circuit during a full-resolution mode and a low-power mode. In various embodiments, the bits stored in the internal register or adder circuit may be stored in a 2′s-complement format.

During full-resolution mode, all of the available bits are used to encode a value indicative of signal 505. When a change is detected in input signal 104, only a portion of the available bits are used to encode a value indicative of signal 506. As illustrated, the four LSBs are not used to encode the value indicative of signal 506. Once filtering is complete, a shift operation may be performed to recover the output signal. Although four LSBs are depicted as being muted in low-power mode, in other embodiments, any suitable number of LSBs can be muted in response to a determination that the detected condition is no longer present.

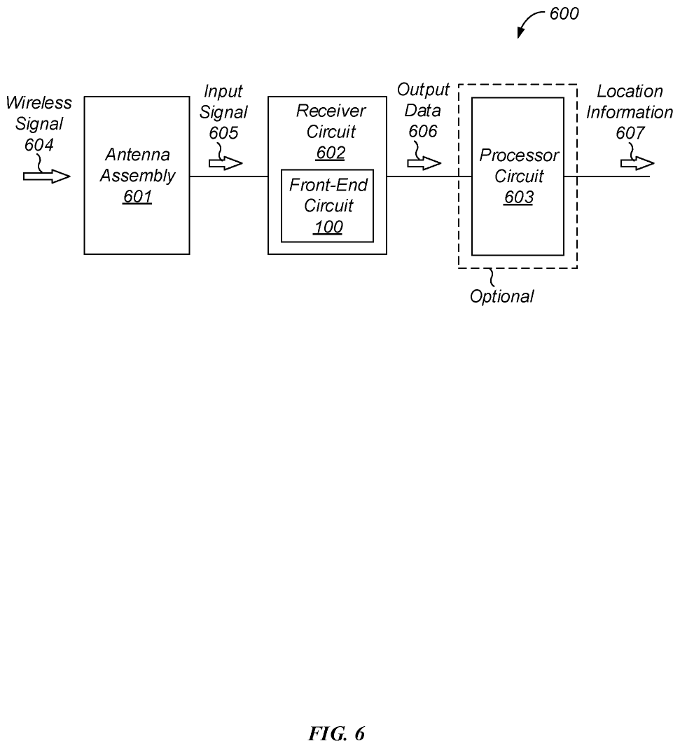

Turning to FIG. 6, a block diagram of a radio-frequency receiver subsystem is depicted. As illustrated, receiver subsystem 600 includes antenna assembly 601, receiver circuit 602, and optional processor circuit 603.

Antenna assembly 601 can include one or more antennas configured to convert the electromagnetic radiation of wireless signal 604 to electric currents and voltage that comprise input signal 605. In some embodiments, antenna assembly 601 may additionally include one or more amplifier circuits to provide drive for input signal 605. Although antenna assembly 601 is depicted as receiving a wireless signal, in other embodiments, antenna assembly 601 may be configured to receive electrical or optical signals and convert them to input signal 605 using amplifier circuits, photodiodes, and the like.

Receiver circuit 602 is configured to receive input signal 605 and generate output data 606. As illustrated, receiver circuit 602 includes front-end circuit 100 as depicted in the embodiment of FIG. 1. As described above, front-end circuit 100 may be configured to detect the presence of signal blockers affecting wireless signal 604, and adjust the resolution of digital circuits included in front-end circuit 100 based on whether or not a signal blocker is present. It is noted that in some cases, receiver circuit 602 may include analog amplifier and filter circuits configured to amplify and filter input signal 605 prior to sampling by front-end circuit 100.

In some embodiments, receiver subsystem 600 includes an optional processor circuit 603. In cases where wireless signal 604 corresponds to a GNSS signal, processor circuit 603 may be configured to generate location information 607 using output data 606. In various embodiments, location information 607 may be relayed to one or more other circuit blocks (not shown) that are included in a computer system that includes receiver subsystem 600. Processor circuit 603 may, in some embodiments, be implemented using a general-purpose processor circuit or a microcontroller circuit configured to execute software or program instructions.

To summarize, various embodiments of a front-end circuit are disclosed. Broadly speaking, a front-end circuit may include an analog-to-digital converter circuit configured to receive an input signal, and sample the input signal to generate a stream of samples that include corresponding pluralities of bits. The front-end circuit may further include a filter circuit configured to filter the stream of samples to generate an output signal. The front-end circuit may additionally include a control circuit configured to perform an analysis of the stream of samples, change, based on a result of the analysis, a first resolution of the analog-to-digital converter circuit, and change, based on the result of the analysis, a second resolution of the filter circuit

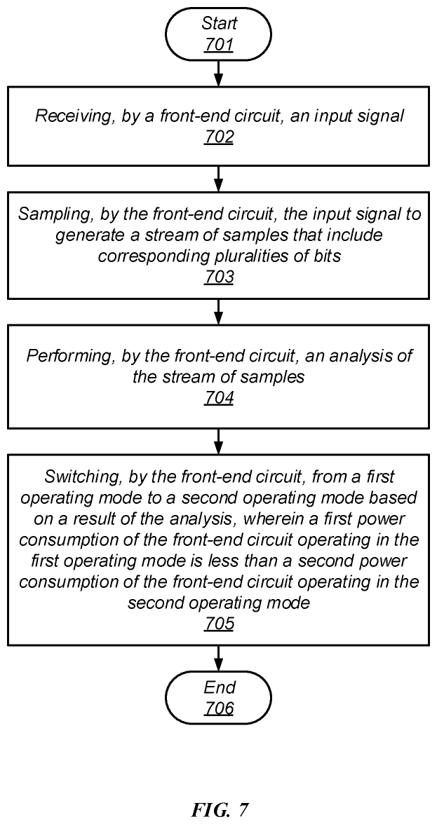

Turning to FIG. 7, a flow diagram depicting an embodiment of a method for operating a front-end circuit is illustrated. The method, which may be applied to various front-end circuits for radio-frequency receivers, begins in block 701.

The method includes receiving, by a front-end circuit, an input signal (block 702). In various embodiments, the front-end circuit is included in a radio-frequency receiver subsystem included in a computer system. In some cases, the computer system may be a mobile computer system, such as a phone, tablet, and the like. In some embodiments, the input signal may be a global navigation satellite system (GNSS) input signal.

The method also includes sampling, by the front-end circuit, the input signal to generate a stream of samples that include corresponding pluralities of bits (block 703). As described above, the front-end circuit may include an analog-to-digital converter circuit, and sampling the input signal may include sampling, by the analog-to-digital converter circuit, the input signal. In various embodiments, a given sample of the stream of samples may include a particular number of bits based on a resolution of the analog-to-digital converter circuit.

The method further include performing, by the front-end circuit, an analysis of the stream of samples (block 704). In some cases, the method further includes detecting a signal blocker using a result of the analysis. Performing the analysis may, in some embodiments, include monitoring a number of clipped samples within a particular period of time, and performing a comparison of the number of clipped samples to a threshold value.

The method also includes switching, by the front-end circuit, from a first operating mode to a second operating mode based on a result of the analysis (block 705). In various embodiments, a first power consumption of the front-end circuit operating in the first operating mode is less than a second power consumption of the front-end circuit operating in the second operating mode. In some cases, switching from the first operating mode to the second operating mode includes switching from the first operating mode to the second operating mode in response to determining a signal blocker is present.

In various embodiments, the front-end circuit includes an analog-to-digital converter circuit and a filter circuit. In such cases, switching from the first operating mode to the second operating mode includes increasing at least one of a first resolution of the analog-to-digital converter circuit or a second resolution of the filter circuit. In some embodiments, both the first resolution and the second resolution may be increased.

In some embodiments, the method may include switching from the second operating mode to the first operating mode in response to determining the blocker is longer present. In such cases, switching from the second operating mode to the first operating mode includes decreasing the first resolution of the analog-to-digital converter circuit, and decreasing the second resolution of the filter circuit. The method concludes in block 706.

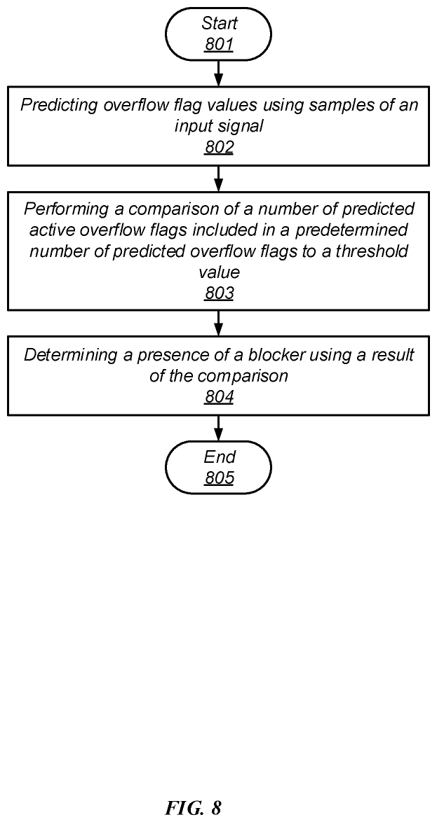

Turning to FIG. 8, a flow diagram of an embodiment of a method for analyzing samples of an input signal is depicted. The method, which may be applied to various front-end circuits, e.g., front-end circuit 100 as depicted in FIG. 1, begins in block 801. In various embodiments, the embodiment of the method depicted in FIG. 8 may correspond to block 704 of the embodiment of the method depicted in FIG. 7.

The method includes predicting overflow flag values using samples of an input signal (block 802). In various embodiments, predicting overflow flag values includes predicting a probability that a next overflow flag value will be active based on a history of a predetermined number of previous overflow flag values. In some cases, predicting overflow flag values may include performing a regression analysis on the predetermined number of previous overflow flag values.

In some embodiments, the method may include scaling the predetermined number of previous overflow flag values by corresponding weights. The values of the corresponding weights may be based on a number of overflow flags used in making the prediction. In general, weight values for more recent overflow flag values may be higher than weight values for older overflow flag values. For a small number of overflow flags used in making the prediction, the corresponding weights may be uniform.

The method also includes performing a comparison of a number of predicted active overflow flags included in a predetermined number of predicted overflow flags to a threshold value (block 803). In cases when front-end circuit is operating in low-power mode, the method may include performing a comparison of the number of predicted active overflow flags to a first threshold value, and when the front-end circuit is operating in high-power mode, the method may include performing a comparison of the number of predicted active overflow flags to a second threshold value different than the first threshold value. It is noted that in some embodiments, the first threshold value and the second threshold value may be the same.

In some embodiments, the method may further include filtering the predicted overflow flags prior to performing the comparison. In various embodiments, filtering the predicted overflow flags may include performing a smoothing filter function, e.g., a Savitzky-Golay filter function. In some embodiments, performing the smoothing filter function may include performing a convolution function, or any other suitable mathematical operation to filter the predicted overflow flags.

The method further includes determining a presence of a blocker using a result of the comparison (block 804). In various embodiments, determining the presence of the blocker may include determining the blocker is present in response to determining that the number of predicted active overflow flags is greater than the first threshold value. Additionally, the method may include determining that a blocker is not present in response to determining that the number of predicted active overflow flags is less than the second threshold value. As described above, the presence of a blocker can be used to switch a front-end circuit from a high-resolution/high-power mode to a low-resolution/low-power mode and vice versa.

The method concludes in block 805. Although the embodiment of the method depicted in FIG. 8 describes the use of predicted overflow flag values, in other embodiments, the method may alternatively employ predicted amplitude values of the input signal, and checking for when such predicted amplitude values become clipped, i.e., the value is greater than the maximum value that can be represented by the number of bits used by front-end circuit 100 during low-power mode.

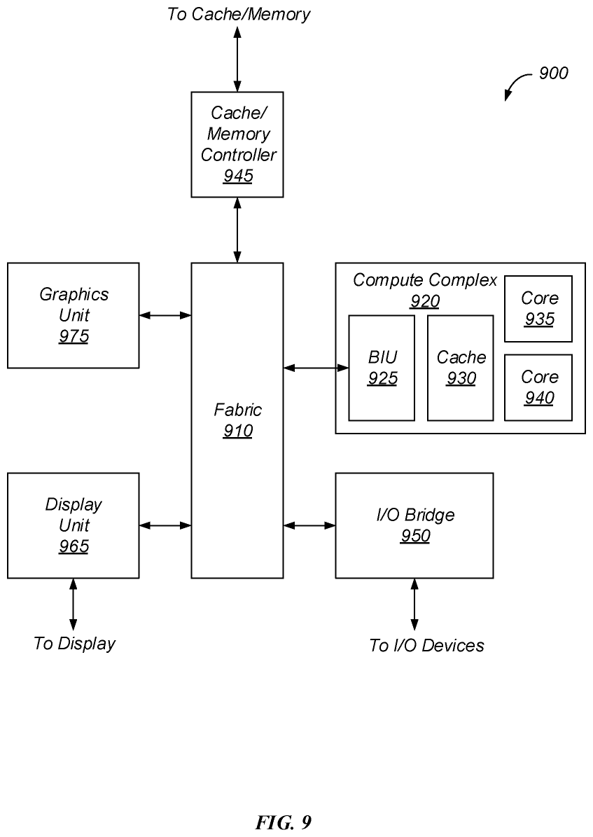

Referring now to FIG. 9, a block diagram illustrating an example embodiment of a device that includes a processor circuit that employs out-of-order completion is shown. In various embodiments, device 900 may be coupled to receiver subsystem 600 as depicted in FIG. 6. In some embodiments, elements of device 900 may be included within a system on a chip. In some embodiments, device 900 may be included in a mobile device, which may be battery-powered. Therefore, power consumption by device 900 may be an important design consideration. In the illustrated embodiment, device 900 includes fabric 910, compute complex 920, input/output (I/O) bridge 950, cache/memory controller 945, graphics unit 975, and display unit 965. In some embodiments, device 900 may include other components (not shown) in addition to, or in place of, the illustrated components, such as video processor encoders and decoders, image processing or recognition elements, computer vision elements, etc.

Fabric 910 may include various interconnects, buses, MUX's, controllers, etc., and may be configured to facilitate communication between various elements of device 900. In some embodiments, portions of fabric 910 may be configured to implement various different communication protocols. In other embodiments, fabric 910 may implement a single communication protocol, and elements coupled to fabric 910 may convert from the single communication protocol to other communication protocols internally.

In the illustrated embodiment, compute complex 920 includes bus interface unit (BIU) 925, cache 930, and cores 935 and 940. In various embodiments, compute complex 920 may include various numbers of processors, processor cores, and caches. For example, compute complex 920 may include 1, 2, or 4 processor cores, or any other suitable number. In one embodiment, cache 930 is a set associative L2 cache. In some embodiments, cores 935 and 940 may include internal instruction and data caches. In some embodiments, a coherency unit (not shown) in fabric 910, cache 930, or elsewhere in device 900, may be configured to maintain coherency between various caches of device 900. BIU 925 may be configured to manage communication between compute complex 920 and other elements of device 900. Processor cores such as cores 935 and 940 may be configured to execute instructions of a particular instruction set architecture (ISA) which may include operating system instructions and user application instructions. These instructions may be stored in a computer readable medium such as a memory coupled to cache memory controller 945 as discussed below.

As used herein, the term “coupled to” may indicate one or more connections between elements, and a coupling may include intervening elements. For example, in FIG. 9, graphics unit 975 may be described as “coupled to” a memory through fabric 910 and cache/memory controller 945. In contrast, in the illustrated embodiment of FIG. 9, graphics unit 975 is “directly coupled” to fabric 910 because there are no intervening elements.

Cache/memory controller 945 may be configured to manage transfer of data between fabric 910 and one or more caches and memories. For example, cache/memory controller 945 may be coupled to an L3 cache which may, in turn, be coupled to a system memory. In other embodiments, cache/memory controller 945 may be directly coupled to a memory. In some embodiments, cache/memory controller 945 may include one or more internal caches. Memory coupled to cache/memory controller 945 may be any type of volatile memory, such as dynamic random access memory (DRAM), synchronous DRAM (SDRAM), double data rate (DDR, DDR2, DDR3, etc.), SDRAM (including mobile versions of SDRAMs such as mDDR3, etc., and/or low power versions of SDRAMs such as LPDDR4, etc.), RAMBUS DRAM (RDRAM), static RAM (SRAM), etc. One or more memory devices may be coupled onto a circuit board to form memory modules such as single inline memory modules (SIMMs), dual inline memory modules (DIMMs), etc. Alternatively, the devices may be mounted with an integrated circuit in a chip-on-chip configuration, a package-on-package configuration, or a multi-chip module configuration. Memory coupled to cache/memory controller 945 may be any type of non-volatile memory such as NAND flash memory, NOR flash memory, nano RAM (NRAM), magneto-resistive RAM (MRAM), phase change RAM (PRAM), Racetrack memory, Memristor memory, etc. As noted above, this memory may store program instructions executable by compute complex 920 to cause the computing device to perform functionality described herein.

Graphics unit 975 may include one or more processors, e.g., one or more graphics processing units (GPUs). Graphics unit 975 may receive graphics-oriented instructions, such as OPENGL®, Metal®, or DIRECT3D® instructions, for example. Graphics unit 975 may execute specialized GPU instructions or perform other operations based on the received graphics-oriented instructions. Graphics unit 975 may generally be configured to process large blocks of data in parallel, and may build images in a frame buffer for output to a display, which may be included in the device or may be a separate device. Graphics unit 975 may include transform, lighting, triangle, and rendering engines in one or more graphics processing pipelines. Graphics unit 975 may output pixel information for display images. Graphics unit 975, in various embodiments, may include programmable shader circuitry, which may include highly parallel execution cores configured to execute graphics programs, which may include pixel tasks, vertex tasks, and compute tasks (which may or may not be graphics-related).

Display unit 965 may be configured to read data from a frame buffer and provide a stream of pixel values for display. Display unit 965 may be configured as a display pipeline in some embodiments. Additionally, display unit 965 may be configured to blend multiple frames to produce an output frame. Further, display unit 965 may include one or more interfaces (e.g., MIPI® or embedded display port (eDP)) for coupling to a user display (e.g., a touchscreen or an external display).

I/O bridge 950 may include various elements configured to implement universal serial bus (USB) communications, security, audio, and low-power always-on functionality, for example. I/O bridge 950 may also include interfaces such as pulse-width modulation (PWM), general-purpose input/output (GPIO), serial peripheral interface (SPI), inter-integrated circuit (I2C), radio-frequency interfaces, for example. Various types of peripherals and devices may be coupled to device 900 via I/O bridge 950. For example, in some cases, receiver subsystem 600 may be coupled to device 900 via I/O bridge 950.

In some embodiments, device 900 includes network interface circuitry (not explicitly shown), which may be connected to fabric 910 or I/O bridge 950. The network interface circuitry may be configured to communicate via various networks, which may be wired, wireless, or both. For example, the network interface circuitry may be configured to communicate via a wired local area network, a wireless local area network (e.g., via Wi-Fi™), or a wide area network (e.g., the Internet or a virtual private network). In some embodiments, the network interface circuitry is configured to communicate via one or more cellular networks that use one or more radio access technologies. In some embodiments, the network interface circuitry is configured to communicate using device-to-device communications (e.g., Bluetooth® or Wi-Fi™ Direct), etc. In various embodiments, the network interface circuitry may provide device 900 with connectivity to various types of other devices and networks.

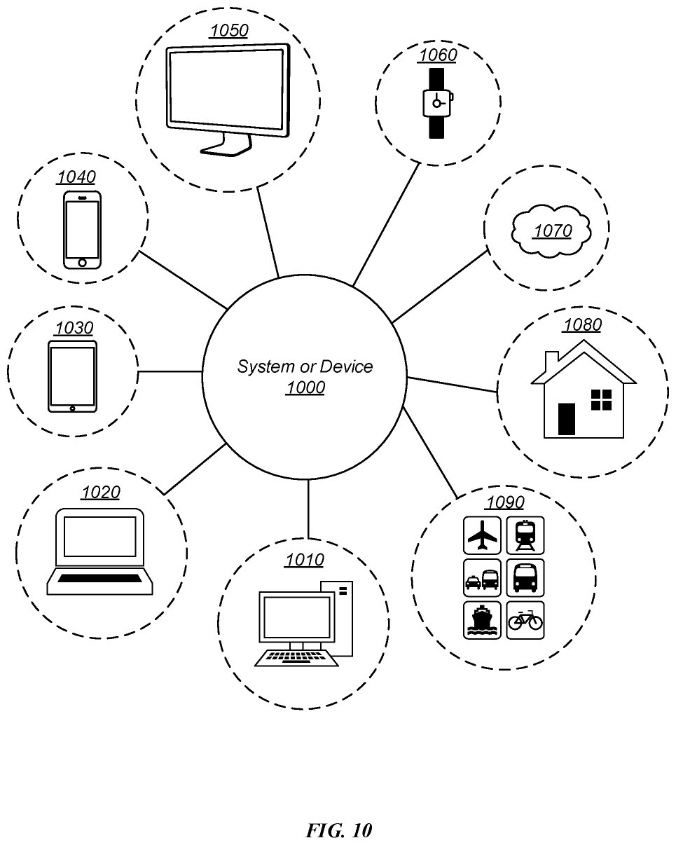

Turning now to FIG. 10, various types of systems that may include any of the circuits, devices, or systems discussed above are illustrated. System or device 1000, which may incorporate or otherwise utilize one or more of the techniques described herein, may be utilized in a wide range of areas. For example, system or device 1000 may be utilized as part of the hardware of systems such as a desktop computer 1010, laptop computer 1020, tablet computer 1030, cellular or mobile phone 1040, or television 1050 (or set-top box coupled to a television).

Similarly, disclosed elements may be utilized in a wearable device 1060, such as a smartwatch or a health-monitoring device. Smartwatches, in many embodiments, may implement a variety of different functions-for example, access to email, cellular service, calendar, health monitoring, etc. A wearable device may also be designed solely to perform health-monitoring functions, such as monitoring a user's vital signs, performing epidemiological functions such as contact tracing, providing communication to an emergency medical service, etc. Other types of devices are also contemplated, including devices worn on the neck, devices implantable in the human body, glasses or a helmet designed to provide computer-generated reality experiences such as those based on augmented and/or virtual reality, etc.

System or device 1000 may also be used in various other contexts. For example, system or device 1000 may be utilized in the context of a server computer system, such as a dedicated server or on shared hardware that implements a cloud-based service 1070. Still further, system or device 1000 may be implemented in a wide range of specialized everyday devices, including devices 1080 commonly found in the home such as refrigerators, thermostats, security cameras, etc. The interconnection of such devices is often referred to as the “Internet of Things” (IoT). Elements may also be implemented in various modes of transportation. For example, system or device 1000 could be employed in the control systems, guidance systems, entertainment systems, etc. of various types of vehicles 1090.

The applications illustrated in FIG. 10 are merely exemplary and are not intended to limit the potential future applications of disclosed systems or devices. Other example applications include, without limitation: portable gaming devices, music players, data storage devices, unmanned aerial vehicles, etc.

The present disclosure has described various example circuits in detail above. It is intended that the present disclosure cover not only embodiments that include such circuitry, but also a computer-readable storage medium that includes design information that specifies such circuitry. Accordingly, the present disclosure is intended to support claims that cover not only an apparatus that includes the disclosed circuitry, but also a storage medium that specifies the circuitry in a format that programs a computing system to generate a simulation model of the hardware circuit, programs a fabrication system configured to produce hardware (e.g., an integrated circuit) that includes the disclosed circuitry, etc. Claims to such a storage medium are intended to cover, for example, an entity that produces a circuit design, but does not itself perform complete operations such as: design simulation, design synthesis, circuit fabrication, etc.

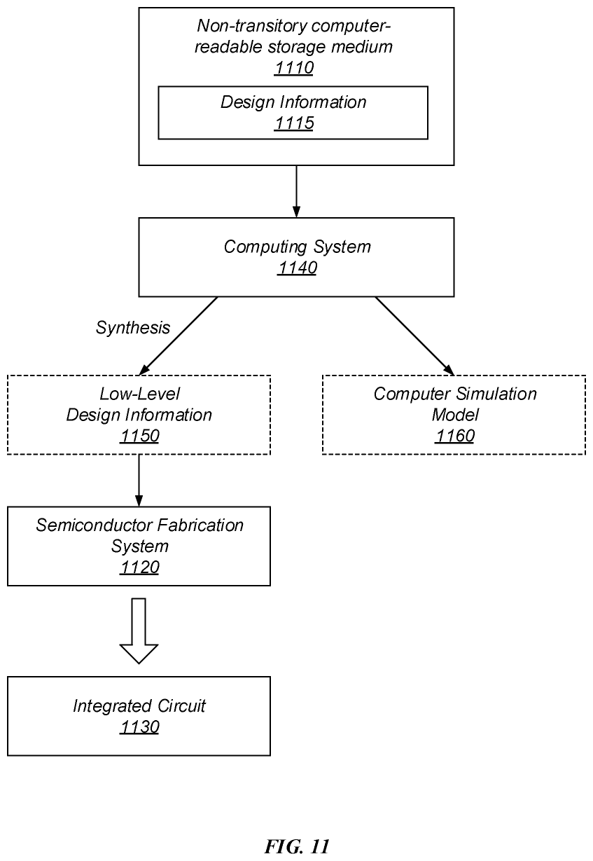

FIG. 11 is a block diagram illustrating an example of a non-transitory computer-readable storage medium that stores circuit design information 1115, according to some embodiments. In the illustrated embodiment, computing system 1140 is configured to process design information 1115. This may include executing instructions included in design information 1115, interpreting instructions included in design information 1115, compiling, transforming, or otherwise updating design information 1115, etc. Therefore, design information 1115 controls computing system 1140 (e.g., by programming computing system 1140) to perform various operations discussed below, in some embodiments.

In the illustrated example, computing system 1140 processes design information 1115 to generate both computer simulation model 1150 of integrated circuit 1130 and low-level design information 1150. In other embodiments, computing system 1140 may generate only one of these outputs, may generate other outputs based on design information 1115, or both. Regarding computer simulation model 1160, computing system 1140 may execute instructions of a hardware description language that includes register transfer level (RTL) code, behavioral code, structural code, or some combination thereof. The simulation model may perform the functionality specified by design information 1115, facilitate verification of the functional correctness of the hardware design, generate power consumption estimates, generate timing estimates, etc.

In the illustrated example, computing system 1140 also processes design information 1115 to generate low-level design information 1150 (e.g., gate-level design information, a netlist, etc.). This may include synthesis operations, as shown, such as constructing a multi-level network, optimizing the network using technology-independent techniques, technology dependent techniques, or both, and outputting a network of gates (with potential constraints based on available gates in a technology library, sizing, delay, power, etc.). Based on low-level design information 1150 (potentially among other inputs), semiconductor fabrication system 1120 is configured to fabricate integrated circuit 1130 (which may correspond to functionality of the computer simulation model 1160). Note that computing system 1140 may generate different simulation models based on design information at various levels of description, including low-level design information 1150, design information 1115, and so on. The data representing low-level design information 1150 and computer simulation model 1160 may be stored on non-transitory computer readable storage medium 1110, or on one or more other media.

In some embodiments, low-level design information 1150 controls (e.g., programs) semiconductor fabrication system 1120 to fabricate integrated circuit 1130. Thus, when processed by the fabrication system, the design information may program the fabrication system to fabricate a circuit that includes various circuitry disclosed herein.

Non-transitory computer-readable storage medium 1110 may comprise any of various appropriate types of memory devices or storage devices. Non-transitory computer-readable storage medium 1110 may be an installation medium, e.g., a CD-ROM, floppy disks, or tape device; a computer system memory or random access memory such as DRAM, DDR RAM, SRAM, EDO RAM, Rambus RAM, etc.; a non-volatile memory such as Flash, magnetic media, e.g., a hard drive, or optical storage; registers, or other similar types of memory elements, etc. Non-transitory computer-readable storage medium 1110 may include other types of non-transitory memory as well or combinations thereof. Accordingly, non-transitory computer-readable storage medium 1110 may include two or more memory media; such media may reside in different locations-for example, in different computer systems that are connected over a network.

Design information 1115 may be specified using any of various appropriate computer languages, including hardware description languages such as, without limitation: VHDL, Verilog, SystemC, System Verilog, RHDL, M, MyHDL, etc. The format of design information 1115 may be recognized by one or more applications executed by computing system 1140, semiconductor fabrication system 1120, or both. In some embodiments, design information 1115 may also include one or more cell libraries that specify the synthesis, layout, or both of integrated circuit 1130. In some embodiments, design information 1115 is specified in whole, or in part, in the form of a netlist that specifies cell library elements and their connectivity. Design information 1115 discussed herein, taken alone, may or may not include sufficient information for fabrication of a corresponding integrated circuit. For example, design information 1115 may specify the circuit elements to be fabricated but not their physical layout. In this case, design information 1115 may be combined with layout information to actually fabricate the specified circuitry.

Integrated circuit 1130 may, in various embodiments, include one or more custom macrocells, such as memories, analog or mixed-signal circuits, and the like. In such cases, design information 1115 may include information related to included macrocells. Such information may include, without limitation, schematics capture database, mask design data, behavioral models, and device or transistor level netlists. Mask design data may be formatted according to graphic data system (GDSII), or any other suitable format.

Semiconductor fabrication system 1120 may include any of various appropriate elements configured to fabricate integrated circuits. This may include, for example, elements for depositing semiconductor materials (e.g., on a wafer, which may include masking), removing materials, altering the shape of deposited materials, modifying materials (e.g., by doping materials or modifying dielectric constants using ultraviolet processing), etc. Semiconductor fabrication system 1120 may also be configured to perform various testing of fabricated circuits for correct operation.

In various embodiments, integrated circuit 1130 and computer simulation model 1160 are configured to operate according to a circuit design specified by design information 1115, which may include performing any of the functionality described herein. For example, integrated circuit 1130 may include any of various elements shown in FIGS. 1-7. Further, integrated circuit 1130 may be configured to perform various functions described herein in conjunction with other components. Further, the functionality described herein may be performed by multiple connected integrated circuits.

As used herein, a phrase of the form “design information that specifies a design of a circuit configured to . . . ” does not imply that the circuit in question must be fabricated in order for the element to be met. Rather, this phrase indicates that the design information describes a circuit that, upon being fabricated, will be configured to perform the indicated actions or will include the specified components. Similarly, stating “instructions of a hardware description programming language” that are “executable” to program a computing system to generate a computer simulation model does not imply that the instructions must be executed in order for the element to be met, but rather, specifies characteristics of the instructions. Additional features relating to the model (or the circuit represented by the model) may similarly relate to characteristics of the instructions, in this context. Therefore, an entity that sells a computer-readable medium with instructions that satisfy recited characteristics may provide an infringing product, even if another entity actually executes the instructions on the medium.

Note that a given design, at least in the digital logic context, may be implemented using a multitude of different gate arrangements, circuit technologies, etc. As one example, different designs may select or connect gates based on design tradeoffs (e.g., to focus on power consumption, performance, circuit area, etc.). Further, different manufacturers may have proprietary libraries, gate designs, physical gate implementations, etc. Different entities may also use different tools to process design information at various layers (e.g., from behavioral specifications to physical layout of gates).

Once a digital logic design is specified, however, those skilled in the art need not perform substantial experimentation or research to determine those implementations. Rather, those of skill in the art understand procedures to reliably and predictably produce one or more circuit implementations that provide the function described by design information 1115. The different circuit implementations may affect the performance, area, power consumption, etc. of a given design (potentially with tradeoffs between different design goals), but the logical function does not vary among the different circuit implementations of the same circuit design.

In some embodiments, the instructions included in design information 1115 provide RTL information (or other higher-level design information) and are executable by the computing system to synthesize a gate-level netlist that represents the hardware circuit based on the RTL information as an input. Similarly, the instructions may provide behavioral information and be executable by the computing system to synthesize a netlist or other lower-level design information included in low-level design information 1150. Low-level design information 1150 may program semiconductor fabrication system 1120 to fabricate integrated circuit 1130.

The present disclosure includes references to an “embodiment” or groups of “embodiments” (e.g., “some embodiments” or “various embodiments”). Embodiments are different implementations or instances of the disclosed concepts. References to “an embodiment,” “one embodiment,” “a particular embodiment,” and the like do not necessarily refer to the same embodiment. A large number of possible embodiments are contemplated, including those specifically disclosed, as well as modifications or alternatives that fall within the spirit or scope of the disclosure.

This disclosure may discuss potential advantages that may arise from the disclosed embodiments. Not all implementations of these embodiments will necessarily manifest any or all of the potential advantages. Whether an advantage is realized for a particular implementation depends on many factors, some of which are outside the scope of this disclosure. In fact, there are a number of reasons why an implementation that falls within the scope of the claims might not exhibit some or all of any disclosed advantages. For example, a particular implementation might include other circuitry outside the scope of the disclosure that, in conjunction with one of the disclosed embodiments, negates or diminishes one or more of the disclosed advantages. Furthermore, suboptimal design execution of a particular implementation (e.g., implementation techniques or tools) could also negate or diminish disclosed advantages. Even assuming a skilled implementation, realization of advantages may still depend upon other factors such as the environmental circumstances in which the implementation is deployed. For example, inputs supplied to a particular implementation may prevent one or more problems addressed in this disclosure from arising on a particular occasion, with the result that the benefit of its solution may not be realized. Given the existence of possible factors external to this disclosure, it is expressly intended that any potential advantages described herein are not to be construed as claim limitations that must be met to demonstrate infringement. Rather, identification of such potential advantages is intended to illustrate the type(s) of improvement available to designers having the benefit of this disclosure. That such advantages are described permissively (e.g., stating that a particular advantage “may arise”) is not intended to convey doubt about whether such advantages can in fact be realized, but rather to recognize the technical reality that realization of such advantages often depends on additional factors.

Unless stated otherwise, embodiments are non-limiting. That is, the disclosed embodiments are not intended to limit the scope of claims that are drafted based on this disclosure, even where only a single example is described with respect to a particular feature. The disclosed embodiments are intended to be illustrative rather than restrictive, absent any statements in the disclosure to the contrary. The application is thus intended to permit claims covering disclosed embodiments, as well as such alternatives, modifications, and equivalents that would be apparent to a person skilled in the art having the benefit of this disclosure.

For example, features in this application may be combined in any suitable manner. Accordingly, new claims may be formulated during prosecution of this application (or an application claiming priority thereto) to any such combination of features. In particular, with reference to the appended claims, features from dependent claims may be combined with those of other dependent claims where appropriate, including claims that depend from other independent claims. Similarly, features from respective independent claims may be combined where appropriate.

Accordingly, while the appended dependent claims may be drafted such that each depends on a single other claim, additional dependencies are also contemplated. Any combinations of features in the dependent claims that are consistent with this disclosure are contemplated and may be claimed in this or another application. In short, combinations are not limited to those specifically enumerated in the appended claims.

Where appropriate, it is also contemplated that claims drafted in one format or statutory type (e.g., apparatus) are intended to support corresponding claims of another format or statutory type (e.g., method).

Because this disclosure is a legal document, various terms and phrases may be subject to administrative and judicial interpretation. Public notice is hereby given that the following paragraphs, as well as definitions provided throughout the disclosure, are to be used in determining how to interpret claims that are drafted based on this disclosure.

References to a singular form of an item (i.e., a noun or noun phrase preceded by “a,” “an,” or “the”) are, unless context clearly dictates otherwise, intended to mean “one or more.” Reference to “an item” in a claim thus does not, without accompanying context, preclude additional instances of the item. A “plurality” of items refers to a set of two or more of the items.

The word “may” is used herein in a permissive sense (i.e., having the potential to, being able to) and not in a mandatory sense (i.e., must).

The terms “comprising” and “including,” and forms thereof, are open-ended and mean “including, but not limited to.”

When the term “or” is used in this disclosure with respect to a list of options, it will generally be understood to be used in the inclusive sense unless the context provides otherwise. Thus, a recitation of “x or y” is equivalent to “x or y, or both,” and thus covers 1) x but not y, 2) y but not x, and 3) both x and y. On the other hand, a phrase such as “either x or y, but not both” makes clear that “or” is being used in the exclusive sense.

A recitation of “w, x, y, or z, or any combination thereof” or “at least one of . . . w, x, y, and z” is intended to cover all possibilities involving a single element up to the total number of elements in the set. For example, given the set [w, x, y, z], these phrasings cover any single element of the set (e.g., w but not x, y, or z), any two elements (e.g., w and x, but not y or z), any three elements (e.g., w, x, and y, but not z), and all four elements. The phrase “at least one of . . . w, x, y, and z” thus refers to at least one element of the set [w, x, y, z], thereby covering all possible combinations in this list of elements. This phrase is not to be interpreted to require that there is at least one instance of w, at least one instance of x, at least one instance of y, and at least one instance of z.

Various “labels” may precede nouns or noun phrases in this disclosure. Unless context provides otherwise, different labels used for a feature (e.g., “first circuit,” “second circuit,” “particular circuit,” “given circuit,” etc.) refer to different instances of the feature. Additionally, the labels “first,” “second,” and “third,” when applied to a feature, do not imply any type of ordering (e.g., spatial, temporal, logical, etc.), unless stated otherwise.

The phrase “based on” is used to describe one or more factors that affect a determination. This term does not foreclose the possibility that additional factors may affect the determination. That is, a determination may be solely based on specified factors, or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

The phrases “in response to” and “responsive to” describe one or more factors that trigger an effect. This phrase does not foreclose the possibility that additional factors may affect or otherwise trigger the effect, either jointly with the specified factors or independent from the specified factors. That is, an effect may be solely in response to those factors, or may be in response to the specified factors as well as other, unspecified factors. Consider the phrase “perform A in response to B.” This phrase specifies that B is a factor that triggers the performance of A, or that triggers a particular result for A. This phrase does not foreclose that performing A may also be in response to some other factor, such as C. This phrase also does not foreclose that performing A may be jointly in response to B and C. This phrase is also intended to cover an embodiment in which A is performed solely in response to B. As used herein, the phrase “responsive to” is synonymous with the phrase “responsive at least in part to.” Similarly, the phrase “in response to” is synonymous with the phrase “at least in part in response to.”

Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical). More specifically, this formulation is used to indicate that this structure is arranged to perform the one or more tasks during operation.

A structure can be said to be “configured to” perform some task even if the structure is not currently being operated. Thus, an entity described or recited as being “configured to” perform some task refers to something physical, such as a device, a circuit, or a system having a processor unit and a memory storing program instructions executable to implement the task, etc. This phrase is not used herein to refer to something intangible.

In some cases, various units/circuits/components may be described herein as performing a set of tasks or operations. It is understood that those entities are “configured to” perform those tasks/operations, even if not specifically noted.

The term “configured to” is not intended to mean “configurable to.” An unprogrammed FPGA, for example, would not be considered to be “configured to” perform a particular function. This unprogrammed FPGA may be “configurable to” perform that function, however. After appropriate programming, the FPGA may then be said to be “configured to” perform the particular function.

For purposes of United States patent applications based on this disclosure, reciting in a claim that a structure is “configured to” perform one or more tasks is expressly intended not to invoke 35 U.S.C. § 112(f) for that claim element. Should Applicant wish to invoke Section 112(f) during prosecution of a United States patent application based on this disclosure, it will recite claim elements using the “means for” [performing a function] construct.

Different “circuits” may be described in this disclosure. These circuits or “circuitry” constitute hardware that includes various types of circuit elements, such as combinatorial logic, clocked storage devices (e.g., flip-flops, registers, latches, etc.), finite state machines, memory (e.g., random-access memory, embedded dynamic random-access memory), programmable logic arrays, and so on. Circuitry may be custom designed, or taken from standard libraries. In various implementations, circuitry can, as appropriate, include digital components, analog components, or a combination of both. Certain types of circuits may be commonly referred to as “units” (e.g., a decode unit, an arithmetic logic unit (ALU), a functional unit, a memory management unit (MMU), etc.). Such units also refer to circuits or circuitry.

The disclosed circuits/units/components and other elements illustrated in the drawings and described herein thus include hardware elements such as those described in the preceding paragraph. In many instances, the internal arrangement of hardware elements within a particular circuit may be specified by describing the function of that circuit. For example, a particular “decode unit” may be described as performing the function of “processing an opcode of an instruction and routing that instruction to one or more of a plurality of functional units,” which means that the decode unit is “configured to” perform this function. This specification of function is sufficient, to those skilled in the computer arts, to connote a set of possible structures for the circuit.

In various embodiments, as discussed in the preceding paragraph, circuits, units, and other elements may be defined by the functions or operations that they are configured to implement. The arrangement of such circuits/units/components with respect to each other and the manner in which they interact form a microarchitectural definition of the hardware that is ultimately manufactured in an integrated circuit or programmed into an FPGA to form a physical implementation of the microarchitectural definition. Thus, the microarchitectural definition is recognized by those of skill in the art as a structure from which many physical implementations may be derived, all of which fall into the broader structure described by the microarchitectural definition. That is, a skilled artisan presented with the microarchitectural definition supplied in accordance with this disclosure may, without undue experimentation and with the application of ordinary skill, implement the structure by coding the description of the circuits/units/components in a hardware description language (HDL) such as Verilog or VHDL. The HDL description is often expressed in a fashion that may appear to be functional. But to those of skill in the art in this field, this HDL description is the manner that is used to transform the structure of a circuit, unit, or component to the next level of implementational detail. Such an HDL description may take the form of behavioral code (which is typically not synthesizable), register transfer language (RTL) code (which, in contrast to behavioral code, is typically synthesizable), or structural code (e.g., a netlist specifying logic gates and their connectivity). The HDL description may subsequently be synthesized against a library of cells designed for a given integrated circuit fabrication technology, and may be modified for timing, power, and other reasons to result in a final design database that is transmitted to a foundry to generate masks and ultimately produce the integrated circuit. Some hardware circuits, or portions thereof, may also be custom-designed in a schematic editor and captured into the integrated circuit design along with synthesized circuitry. The integrated circuits may include transistors and other circuit elements (e.g., passive elements such as capacitors, resistors, inductors, etc.) and interconnect between the transistors and circuit elements. Some embodiments may implement multiple integrated circuits coupled together to implement the hardware circuits, and/or discrete elements may be used in some embodiments. Alternatively, the HDL design may be synthesized to a programmable logic array such as a field programmable gate array (FPGA) and may be implemented in the FPGA. This decoupling between the design of a group of circuits and the subsequent low-level implementation of these circuits commonly results in the scenario in which the circuit or logic designer never specifies a particular set of structures for the low-level implementation beyond a description of what the circuit is configured to do, as this process is performed at a different stage of the circuit implementation process.

The fact that many different low-level combinations of circuit elements may be used to implement the same specification of a circuit results in a large number of equivalent structures for that circuit. As noted, these low-level circuit implementations may vary according to changes in the fabrication technology, the foundry selected to manufacture the integrated circuit, the library of cells provided for a particular project, etc. In many cases, the choices made by different design tools or methodologies to produce these different implementations may be arbitrary.

Moreover, it is common for a single implementation of a particular functional specification of a circuit to include, for a given embodiment, a large number of devices (e.g., millions of transistors). Accordingly, the sheer volume of this information makes it impractical to provide a full recitation of the low-level structure used to implement a single embodiment, let alone the vast array of equivalent possible implementations. For this reason, the present disclosure describes structure of circuits using the functional shorthand commonly employed in the industry.

What is claimed is:

1. An apparatus, comprising:
an analog-to-digital converter circuit configured to:
receive an input signal; and
sample the input signal to generate a stream of samples that include corresponding pluralities of bits;
a filter circuit configured to filter the stream of samples to generate an output signal; and
a control circuit configured to:
perform an analysis of the stream of samples;
change, based on a result of the analysis, a first resolution of the analog-to-digital converter circuit; and
change, based on the result of the analysis, a second resolution of the filter circuit.

2. The apparatus of claim 1, wherein to perform the analysis, the control circuit is further configured to:
determine a number of clipped samples over a particular period of time; and
perform a comparison of the number of clipped samples to at least one threshold value.

3. The apparatus of claim 2, wherein to change the first resolution of the analog-to-digital converter circuit, the control circuit is further configured to:
increase the first resolution in response to a determination that the number of clipped samples exceeds a first threshold value; and
decrease the first resolution in response to a determination that the number of clipped samples is less than a second threshold value.

4. The apparatus of claim 3, wherein the second threshold value is the same as the first threshold value.

5. The apparatus of claim 1, wherein to perform the analysis of the stream of samples, the control circuit is further configured to predict, at a particular point in time, a value of an overflow using a subset of the stream of samples received prior to the particular point in time.

6. The apparatus of claim 1, wherein the input signal includes a global navigation satellite system input signal.

7. A method, comprising:
receiving, by a front-end circuit, an input signal;
sampling, by the front-end circuit, the input signal to generate a stream of samples that include corresponding pluralities of bits;
performing an analysis of the stream of samples; and
switching, by the front-end circuit, from a first operating mode to a second operating mode based on a result of the analysis, wherein a first power consumption of the front-end circuit operating in the first operating mode is less than a second power consumption of the front-end circuit operating in the second operating mode.

8. The method of claim 7, further comprising detecting a signal blocker using the result of the analysis, and wherein switching from the first operating mode to the second operating mode includes switching from the first operating mode to the second operating mode in response to determining a signal blocker is present.

9. The method of claim 8, wherein the front-end circuit includes an analog-to-digital converter circuit and a filter circuit, and wherein switching from the first operating mode to the second operating mode includes increasing at least one of a first resolution of the analog-to-digital converter circuit or a second resolution of the filter circuit.

10. The method of claim 8, further comprising switching from the second operating mode to the first operating mode in response to determining the blocker is no longer present.

11. The method of claim 10, wherein the front-end circuit includes an analog-to-digital converter circuit and a filter circuit, and wherein switching from the second operating mode to the first operating mode includes:
decreasing a first resolution of the analog-to-digital converter circuit; and
decreasing a second resolution of the filter circuit.

12. The method of claim 8, wherein performing the analysis includes:
monitoring a number of clipped samples within a particular period of time; and
performing a comparison of the number of clipped samples to a threshold value.

13. The method of claim 7, wherein the input signal includes a global navigation satellite system input signal.

14. An apparatus, comprising:
a processor circuit; and
a receiver circuit including a front-end circuit configured to:
receive an input signal;
sample the input signal to generate a stream of samples that include corresponding pluralities of bits;
send the stream of samples to the processor circuit;
perform an analysis of the stream of samples; and
switch from a first operating mode to a second operating mode based on a result of the analysis, wherein a first power consumption of the front-end circuit operating in the first operating mode is less than a second power consumption of the front-end circuit operating in the second operating mode.

15. The apparatus of claim 14, wherein to perform the analysis of the stream of samples, the receiver circuit is further configured to predict, at a particular point in time, a value of an overflow using a subset of the stream of samples received prior to the particular point in time, wherein the front-end circuit is further configured to detect a signal blocker using the result of the analysis, and wherein to switch from the first operating mode to the second operating mode, the front-end circuit is further configured to switch from the first operating mode to the second operating mode in response to a determination that a blocker is interfering with the input signal.

16. The apparatus of claim 15, wherein the front-end circuit includes an analog-to-digital converter circuit and a filter circuit, and wherein to switch from the first operating mode to the second operating mode, the front-end circuit is further configured to:
increase a first resolution of the analog-to-digital converter circuit; and
increase a second resolution of the filter circuit.

17. The apparatus of claim 15, wherein the front-end circuit is further configured to switch from the second operating mode to the first operating mode in response to a determination that the input signal is not being blocked.

18. The apparatus of claim 17, wherein the front-end circuit includes an analog-to-digital converter circuit and a filter circuit, and wherein to switch from the second operating mode to the first operating mode, the front-end circuit is further configured to:
decrease a first resolution of the analog-to-digital converter circuit; and
decrease a second resolution of the filter circuit.

19. The apparatus of claim 14, wherein to perform the analysis, the front-end circuit is further configured to:
monitor a number of clipped samples within a particular period of time; and
perform a comparison of the number of clipped samples to a threshold value.

20. The apparatus of claim 14, wherein the input signal includes a global navigation satellite system input signal.
